(19) United States
(12) Patent Application Publication
(10) Pub. No.: US 2010/0244339 A1
(43) Pub. Date: Sep. 30, 2010

(54) FILTER HAVING MULTILAYERED STRUCTURE FOR FILTERING IMPURITY PARTICLES FROM MOLTEN METAL

(75) Inventors: Eui-Han Yoon, Gyeonggi-do (KR); Beom-Su Kwak, Gyeonggi-do (KR); Ten Edis Borisovich, Moscow (RU)

Correspondence Address: Nixon Peabody LLP, P.O. Box 60610, Palo Alto, CA, 94306, US

(73) Assignee: DAECHANG CO., LTD., Siheung-city, Gyeonggi-do (KR)

(21) Appl. No.: 12/739,954

(22) PCT Filed: Jul. 21, 2008
(86) PCT No.: PCT/KR2008/004245

§ 371 Date: Apr. 26, 2010

(30) Foreign Application Priority Data
Oct. 30, 2007 (KR) 10-2007-0109753

(51) Int. Cl. B01D 39/00; C21C 7/00

(52) U.S. Cl. 266/227

(57) ABSTRACT

A filter has a multi-layered structure for removing impurity particles from a molten metal. The filter includes: a plurality of filter layers sequentially disposed along the flow direction of the molten metal in a downward direction and comprising a plurality of pore channels, wherein the filter layers disposed upstream comprise larger pore channels than those of the filter layers disposed downstream.

### CROSS-REFERENCE TO RELATED PATENT APPLICATION

This application is a national phase International Application No. PCT/KR2008/004245, entitled, “FILTER HAVING MULTILAYERED STRUCTURE FOR FILTERING IMPURITY PARTICLES FROM MOLTEN METAL”, which was filed on Jul. 21, 2008, and which claims priority of Korean Patent Application No. 10-2007-0109753, filed Oct. 30, 2007, in the Korean Intellectual Property Office, the contents of which are incorporated herein by reference.

### TECHNICAL FIELD

The present invention relates to a filter having a multi-layered structure for removing impurity particles from a molten metal, and more particularly, to a filter having an improved multi-layered structure for removing impurity particles such as lead, bismuth, and so forth, from a molten metal.

### BACKGROUND ART

The latest strictest regulation on the world environment is the Rio Earth Charter on Environment and Development, which was produced at the United Nations Conference on Environment and Development (UNCED) in 1992. Since then, RoHS, Restriction of Hazardous Substances, which was proposed by European Parliament in 2002, restricts the use of six hazardous substances. In detail, the six hazardous substances are Pb, Hg, Cr⁺⁶, Cd, polybrominated biphenyl (PBBs), and polybrominated diphenyl ether (PBDE). Under the circumstances, it is required worldwide to reduce the lead content in, for example, copper alloy. When a pure material such as electrolytic copper is used, there is no environmental problem, but the manufacturing costs increase. On the other hand, to manufacture brass products containing a small content of lead, cheap brass scraps need to be used. However, lead in the amount of 1-4 wt % exists in these scraps, and thus cheap brass scraps cannot be used in large quantities. Thus, various methods as illustrated in FIGS. 1 and 2 are used in combination in order to remove impurities such as lead from the copper alloy. In other words, by adding an additive and a reactant to a molten copper alloy, impurities such as lead is oxidized or an inter-metal compound is generated, and then, impurities in the form of a slag 2 which rises to the surface of the molten metal are taken out from the molten metal. Meanwhile, impurities 3, which are mixed in the form of particles in the molten metal, are removed using a filter 1 as illustrated in FIG. 2.

The principle of removing impurities contained as particles in the molten metal is illustrated in FIGS. 3 and 4. FIG. 3 illustrates removal of impurities 3 by cake filtration. That is, by the cake filtration, the impurities 3 hanging on pore channels 4 of the filter form a second filter having smaller pore channels above the filter 1 than before, and thus the impurities 3 which are smaller than the pore channel 4 of the filter 1 can be filtered. This principle is also referred to as a screen effect.

FIG. 4 illustrates removal of impurities by depth filtration, which is also referred to as an adhesion effect. In FIG. 4, A shows removal of impurities by a direct blocking effect. The direct blocking effect can be conducted as the impurities 3 strike inner surfaces of the pore channels 4 along the track of the pore channel 4. In FIG. 4, B shows a gravity effect, whereby gravity acts on particles that are pulled by the impurities 3, which are filtered by the filter 1, and the impurities 3 deviate from a normal path and adhere to walls of the pore channels 4. In FIG. 4, C shows a Brownian motion effect, whereby the impurities 3 deviate from the ordinary orbit by collision between and adhere to the walls of the pore channels 4. In FIG. 4, D shows an inertia effect, whereby the impurities 3 do not change their direction while passing through the pore channels 4 due to inertia and collide with the walls of the pore channels 3, thereby adhering to the walls of the pore channels 4. In FIG. 4, E shows a hydrodynamic effect, whereby the impurities 3 are caught in a dead zone of a flow and adhere to the walls of the pore channels 4. From among these, effects A, D, and E show high efficiency in removing the impurities 3.

To this end, filters such as a lattice filter in the form of a cloth manufactured of glass fiber, a ceramic extrusion filter having a circular or quadrangle channel, or a ceramic foam filter having irregular pore channels have been used in the conventional art.

However, the lattice filter has low filtering efficiency because it filters the impurities 3 only by the screen effect.

Meanwhile, the ceramic extrusion filter filters the impurities 3 by the screen effect and an adhesion effect; however, this filter has pore channels 4 with uniform cross-sections, and thus the filtering efficiency by the adhesion effect is low. Also, the ceramic foam filter removes impurities by the screen effect and the adhesion effect. However, the ceramic foam filter includes various meandering pore channels 4 with varying cross-sections. Thus, the ceramic foam filter has better impurity filtering efficiency than the ceramic extrusion filter. However, the cross-sections of the pore channels 4 of the ceramic foam filter are uniform in the length direction thereof. As a result, the filtering efficiency at the entrance of the pore channel 4 is good but the filtering efficiency decreases toward the outlet of the pore channels 4. In detail, a 5 ppi (pores per square inch) ceramic foam filter is not manufactured because the pore channels 4 are too large and the filtering efficiency is too low. Also, with a ceramic foam filter having relatively large pore channels of 10 and 20 ppi, non-metal impurities are hardly filtered. Meanwhile, although small non-metal impurities 3 can be easily filtered with a ceramic foam filter having relatively small pore channels of 40 and 50 ppi, a high flow resistance is applied to the ceramic foam filter and thus it is difficult for the molten metal to pass through the entire ceramic foam filter. Accordingly, 30 ppi pore channels are appropriate. However, impurity particles that are larger than the pore channels 4 may block the pore channels 4 at the beginning of filtering, and thus further filtering effect cannot be obtained.

### DETAILED DESCRIPTION OF THE INVENTION

### Technical Problem

The present invention provides a filter having an improved multi-layered structure for removing impurity particles from a molten metal so that an efficient filtering effect can be obtained from the inlet to the outlet of the pore channels, wherein a plurality of filter layers in the filter comprise variously-sized pore channels.

### Advantageous Effects

The filter having a multi-layered structure for removing impurity particles from a molten metal according to the present invention includes pore channels having sizes that are decreased sequentially in a downward direction of the flow of the molten metal. Accordingly, the impurity particles can be removed in a more efficient manner.

### DESCRIPTION OF THE DRAWINGS

FIGS. 1 and 2 are schematic views for explaining the general idea of removing impurities from a molten metal;

FIGS. 3 and 4 are schematic views for explaining the principle of filtering impurities from a molten metal using a filter;

FIG. 5 is a partially cut perspective view of a filter having a multi-layered structure for removing impurities from a molten metal, according to an embodiment of the present invention;

FIG. 6 is a cross-sectional view of the filter cut along a VI-VI line of FIG. 5;

FIG. 7 is a cross-sectional view of the filter cut along a VII-VII line of FIG. 5;

FIG. 8 is a cross-sectional view of the filter cut along a VIII-VIII line of FIG. 5; and

FIGS. 9 through 11 illustrate experimental equipment for examining the filtering effect of the present invention and the results of experiments conducted using the experimental equipment.

### BEST MODE

The present invention will now be described more fully with reference to the accompanying drawings, in which exemplary embodiments of the invention are shown.

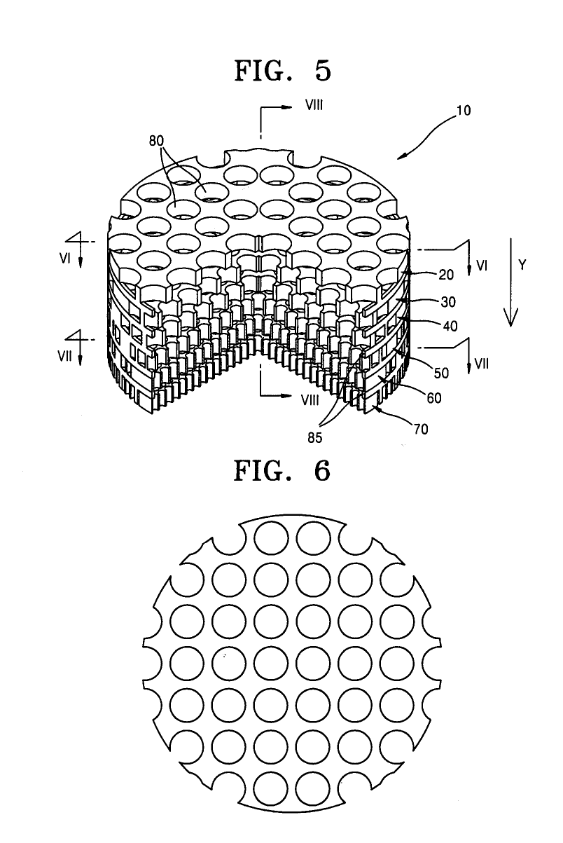

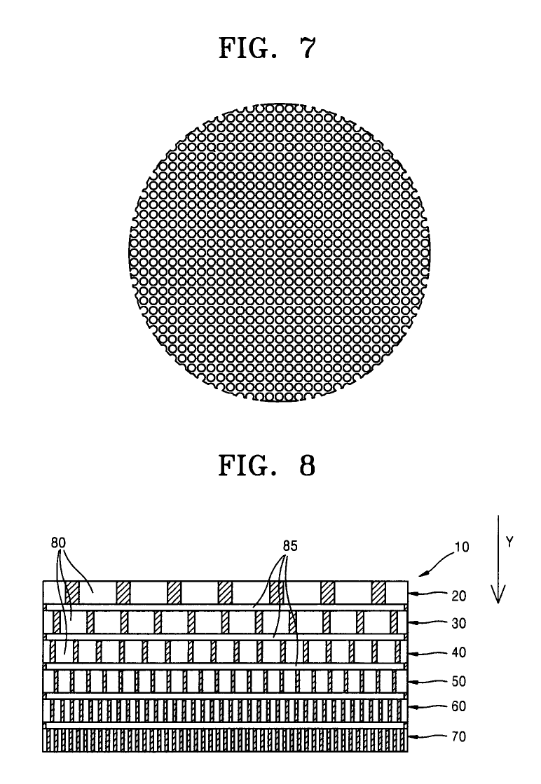

FIG. 5 is a partially cut perspective view of a filter having a multi-layered structure for removing impurities from a molten metal, according to an embodiment of the present invention. FIG. 6 is a cross-sectional view of the filter cut along a VI-VI line of FIG. 5. FIG. 7 is a cross-sectional view of the filter cut along a VII-VII line of FIG. 5. FIG. 8 is a cross-sectional view of the filter cut along a VIII-VIII line of FIG. 5.

Referring to FIGS. 5 through 8, a filter 10 having a multi-layered structure for removing impurities from a molten metal according to an embodiment of the present invention (hereinafter referred to as filter having a multi-layered structure or a gradient porous filter (GPF)) is used to remove impurity particles from a molten metal. The filter 10 having a multi-layered structure includes a plurality of filter layers 20, 30, 40, 50, 60, and 70. The filter layers 20, 30, 40, 50, 60, and 70 are sequentially disposed in a flow direction Y of the molten metal, that is, in a downstream direction. Pore channels 80 are formed in each of the plurality of the filter layers 20, 30, 40, 50, 60, and 70. Among the filter layers 20, 30, 40, 50, 60, and 70, filter layers disposed upstream include larger pore channels 80 than those of filter layers disposed downstream. A flow resistance buffer layer 85, which temporarily receive the molten metal, is formed between each two of the filter layers. The flow resistance buffer layer 85 does not include the pore channel 80 and accommodates the molten metal temporarily before the molten metal that has passed through the filter layers flows to a next filter layer. Thus, when the volume of the flow resistance buffer layer 85 increases, the flow resistance of the molten metal that passes through each of the filter layers 20, 30, 40, 50, 60, and 70 decreases. However, after the volume of the flow resistance buffer layer 85 reaches a predetermined value, the filtering effects remain constant.

For example, when the molten metal is a copper alloy, the impurity particles may be compounds containing at least one of lead (Pb), bismuth (Bi), iron (Fe), and silicon (Si) that are contained in the copper alloy. The plurality of the filter layers 20, 30, 40, 50, 60, and 70 are formed of ceramics.

The plurality of the filter layers 20, 30, 40, 50, 60, and 70 comprise a first filter layer 20, a second filter layer 30, a third filter layer 40, a fourth filter layer 50, a fifth filter layer 60, and a sixth filter layer 70 sequentially in a downward direction. The above-described flow resistance buffer layer 85 is formed between each two of the filter layers.

The density of the pore channels 80 of the first filter layer 20 is 5 ppi (pores per square inch).

The density of the pore channels 80 of the second filter layer 30 is 10 ppi.

The density of the pore channels 80 of the third filter layer 40 is 15 ppi.

The density of the pore channels 80 of the fourth filter layer 50 is 20 ppi.

The density of the pore channels 80 of the fifth filter layer 60 is 25 ppi.

The density of the pore channels 80 of the sixth filter layer 70 is 30 ppi.

The density of the pore channels 80 of the plurality of the filter layers is set based on a conventional ceramic foam filter. However, the distances between the pore channels 80 is designed to be greater than in the conventional ceramic foam filter according to the results of a computer analysis. In detail, for example, the size of the pore channel 80 formed in the first filter layer 20 is 4.38 mm; however, a pore channel of the conventional ceramic foam filter corresponding thereto is 4.98 mm. The number of the pore channels 80 of the first filter layer 20 is the same as the number of the pore channels of the conventional ceramic foam filter, but since the size of each of the pore channels 80 of the first filter layer 20 of the present invention is smaller than that of the pore channel of the conventional ceramic foam filter, the distances between the pore channels 80 of the first filter layer 20 are larger.

According to the current embodiment, the total cross-sections of the pore channels 80 of each of the filter layers are designed to be identical to one another. In detail, for example, the total cross-sections of the pore channels 80 formed in the first filter layer 20 and the total cross-sections of the pore channels 80 formed in the second filter layer 30 are identical to one another. Also, when the total cross-sections of the pore channels 80 of the filter layers disposed downstream are larger than the total cross-sections of the pore channels 80 of the filter layers disposed upstream, a flow resistance is hardly generated in the molten metal. Accordingly, the flow resistance of the molten metal that passes through the first filter layer 20 and the second filter layer 30 can be minimized.

Meanwhile, the cross-sections of the pore channels 80 of each of the filter layers are identical to each other. For example, pores formed in the first filter layer 20 have circular cross-sections and are 4.38 mm in diameter, regularly, and the pores formed in the second filter layers 30 are circular cross-sections and are 1.84 mm in diameter, regularly.

Also, as in the current embodiment, the number of the pore channels 80 of the filter layers disposed upstream may preferably be smaller than the number of the pore channels 80 of the filter layers disposed downstream. That is, while the number of the pore channels 80 of the first filter layer 20 is 5 ppi, the number of the pore channels 80 of the second filter layer 30 that is disposed below the first filter layer 20 is 10 ppi.

Hereinafter, the operation of the filter 10 having a multi-layered structure according to the current embodiment of the present invention as described above will be described with reference to a process of a molten metal passing through the first filter through sixth filter layers 20, 30, 40, 50, 60, and 70.

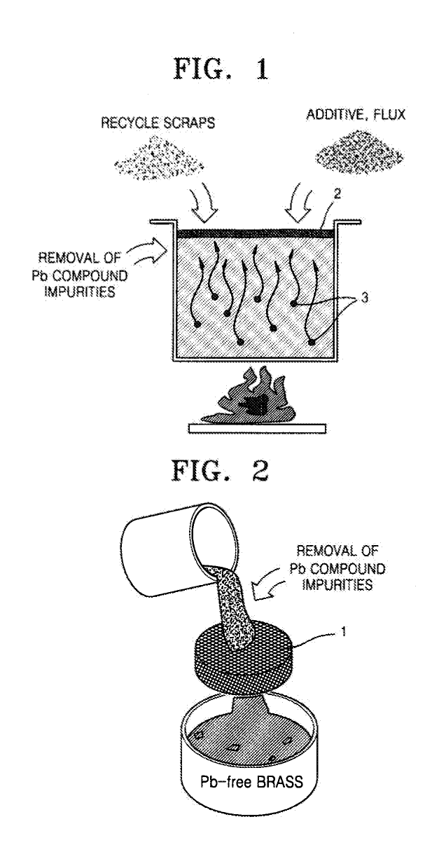

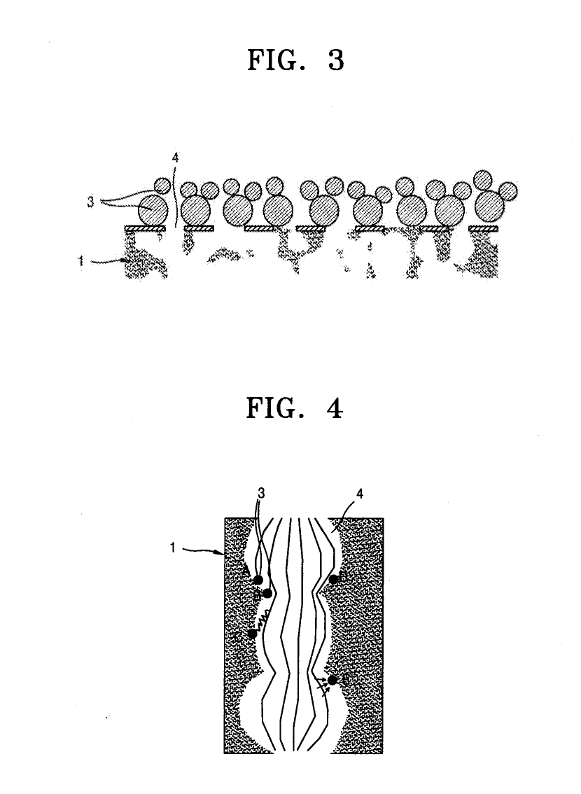

First, an oxide or a compound containing lead or bismuth is assumed to be mixed as impurity particles in the molten metal according to the current embodiment of the present invention. The molten metal is passed through the filter 10 having a multi-layered structure as illustrated in FIG. 2. The first filter layer 20 is disposed upstream of the flow direction Y of the molten metal. Also, the second, third, fourth, fifth, and sixth filter layers 20, 30, 40, 50, 60, and 70 are sequentially disposed along the flow direction Y of the molten metal, that is, in a downstream direction. The flow resistance buffer layer 85 is formed between each two of the filter layers.

First, the molten metal is passed through from the entrance of the first filter layer 20 and then to the outlet thereof. Here, impurity particles that are larger than the size of the pore channels 80 formed in the first filter layer 20 are removed by the screen effect. Also, while the impurity particles that are smaller than the pore channels 80 formed in the first filter layer 20 pass through the pore channels 80, some of the impurity particles are removed by depth filtration, which has been described above with reference to FIG. 4. The molten metal that has passed through the first filter layer 20 arrives at the flow resistance buffer layer 85. The flow resistance buffer layer 85 temporarily accommodates the molten metal that has passed through the plurality of the pore channels 80 formed in the first filter layer 20 again in one space. Next, the molten metal accommodated in the flow resistance buffer layer 85 flows into the second filter layer 30. Smaller pore channels 80 than those of the first filter layer 20 are formed in the second filter layer 30. Accordingly, while small impurity particles that have passed through the first filter layer 20 are removed by the screen effect and the depth filtration in the second filter layer 30, the molten metal passes through the passes through the second filter layer 30. Thus, gradually smaller impurity particles pass through the third, fourth, fifth, and sixth filter layers 40, 50, 60, and 70 sequentially and most of them are removed. The filter 10 having a multi-layered structure according to the current embodiment of the present invention can easily remove both large and small impurity particles compared to the conventional ceramic foam filter, and flow resistance is also reduced.

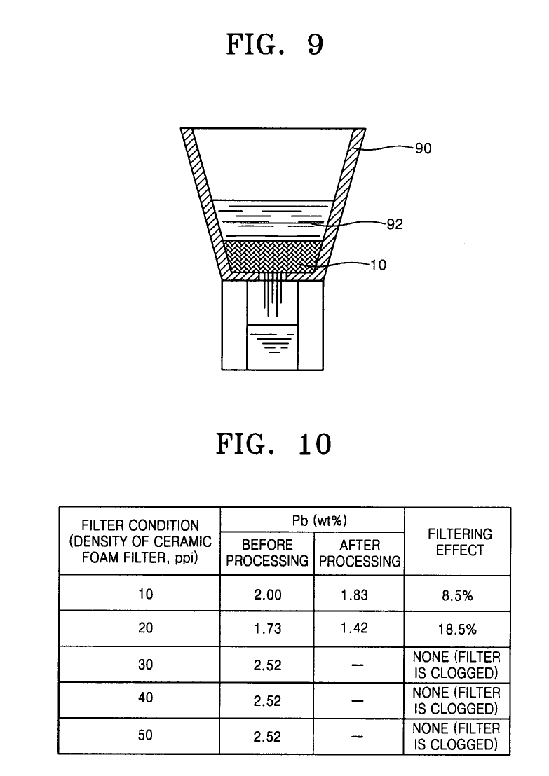

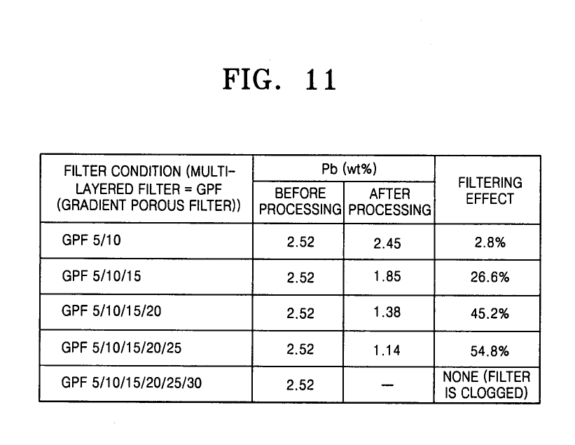

FIG. 9 illustrates experimental equipment for examining the impurity removal effect of the filter 10 having a multi-layered structure according to the current embodiment of the present invention. Referring to FIG. 9, after the filter 10 having a multi-layered structure was mounted on a crucible 90, a molten metal, specifically, a molten copper alloy 92, was poured into the crucible 90. The equipment including the crucible 90 was heated up to 900 before pouring the molten metal 92. To examine the performance of the filter 10 of removing impurities, that is, the performance of removing Pb, a conventional ceramic foam filter having pore channel densities of 10, 20, 30, 40, and 50 ppi was also examined for comparison. The results are shown in FIG. 10. Referring to FIG. 10, the filtering effect of the ceramic foam filter having a pore channel density of 10 ppi was 8.5%, and the filtering effect of the ceramic foam filter having a pore channel density of 20 ppi was 18.5%. However, the ceramic foam filters having pore channel densities of 30, 40, and 50 ppi did not show any filtering effect because the pore channels of the ceramic foam filters were too small and thus the pore channels were clogged. Compared with this, the results of the case when the filter 10 having a multi-layered structure according to the present invention is used are shown in FIG. 11. Referring to FIG. 11, a two-layered filter with pore channel densities of 5 and 10 ppi for each filter layer has a filtering effect of 2.8%. This result showed the low performance of the conventional ceramic foam filter having a pore channel density of 10 ppi. However, a filter having three-layered structure with pore channel densities of 5, 10, and 15 ppi showed a filtering effect of 26.6%. Also, a filter having a four-layered structure with pore channel densities of 5, 10, 15, and 20 ppi showed a filtering effect of 45.2%. In addition, a filter having a five-layered structure with pore channel densities of 5, 10, 15, 20, and 25 ppi showed an excellent filtering effect of 54.8%. However, in the case of a filter having a six-layered structure having filter layers with pore channels 80 having densities of 5, 10, 15, 20, 25, and 30 ppi, the pore channels 80 were clogged and thus no filtering effect could be obtained. In such a case with fine pore channels 80, to filtering effects can be obtained only when pressure is sufficiently applied to the molten metal 92.

Although the total cross-sections of the pore channels of each of the filter layers of the current embodiment of the present invention are described to be identical to one another, the effect of the present invention can be obtained also when the total cross-sections of the pore channels of each of the filter layers are different, while the flow resistance may be either increased or decreased.

According to the present invention, the pore channels formed in each of the filter layers are described to have identical cross-sections within the same filter layer. However, the pore channels may also have different cross-sections within the same filter layer.

According to the present invention, the number of the pore channels of the filter layers disposed upstream is described to be less than the number of the pore channels of the filter layers disposed downstream. However, the number of the pore channels of the filter layers disposed upstream may also be greater than the number of the pore channels of the filter layers disposed downstream.

According to the present invention, a flow resistance buffer layer which temporarily accommodates a molten metal is formed between each of the filter layers. However, even the flow resistance buffer layer is not formed and the flow resistance may increase a little bit, the effect of the present invention can be obtained.

According to the present invention, the impurity particles are described to be compounds containing at least one of lead (Pb), bismuth (Bi), iron (Fe), and silicon (Si). However, the impurity particles may be compounds containing other elements such as cadmium (Cd).

According to the present invention, the plurality of the filter layers are described to be formed of ceramics. However, the filter layers may be formed of any other material as long as the filter layers are not damaged by the molten metal.

According to the present invention, the plurality of the filter layers are described to sequentially comprise first, second, third, fourth, fifth, and sixth filter layers in a downward direction. However, the effect of the prevent invention can be obtained also with some of these filter layers not included or other layers further included as long as the molten metal can easily pass through the filter layers.

While the present invention has been particularly shown and described with reference to exemplary embodiments thereof, it will be understood by those of ordinary skill in the art that various changes in form and details may be made therein without departing from the spirit and scope of the present invention as defined by the following claims.

### MODE OF THE INVENTION

According to an aspect of the present invention, there is provided a filter having a multi-layered structure for removing impurity particles from a molten metal, comprising: a plurality of filter layers sequentially disposed along the flow direction of the molten metal in a downward direction and comprising a plurality of pore channels, wherein the filter layers disposed upstream comprise larger pore channels than those of the filter layers disposed downstream.

The total cross-sections of the pore channels of each of the filter layers may be identical to one another, or the total cross-sections of the pore channels of the filter layers disposed downstream are greater than the total cross-sections of the pore channels of the filter layers disposed upstream.

The cross-sections of the pore channels within each of the filter layers may be identical to one another.

The number of the pore channels of the filter layers disposed upstream may be smaller than the number of the pore channels of the filter layers disposed downstream.

A flow resistance buffer layer that temporarily receives the molten metal may be formed between each two of the filter layers.

The impurity particles may be compounds containing at least one of lead (Pb), bismuth (Bi), iron (Fe), and silicon (Si).

The filter layers may be formed of ceramics.

The plurality of the filter layers may comprise a first, second, third, fourth, fifth, and sixth filter layers, sequentially in a downstream direction, wherein the density of the pore channels of the first filter layer is 5 ppi (pores per square inch), and the density of the pore channels of the second filter layer is 10 ppi, and the density of the pore channels of the third filter layer is 15 ppi, and the density of the pore channels of the fourth filter layer is 20 ppi, and the density of the pore channels of the fifth filter layer is 25 ppi, and the density of the pore channels of the sixth filter layer is 30 ppi.

### INDUSTRIAL APPLICABILITY

The filter having a multi-layered structure for removing impurity particles from a molten metal according to the present invention includes pore channels having sizes that are being sequentially decreasing in a downward direction of the flow of the molten metal. Accordingly, the impurity particles can be removed in a more efficient manner.

1. A filter having a multi-layered structure for removing impurity particles from a molten metal, comprising:
a plurality of filter layers sequentially disposed along the flow direction of the molten metal in a downward direction and comprising a plurality of pore channels,
wherein the filter layers disposed upstream comprise larger pore channels than those of the filter layers disposed downstream.

2. The filter having a multi-layered structure of claim 1, wherein the total cross-sections of the pore channels of each of the filter layers are identical to one another, or the total cross-sections of the pore channels of the filter layers disposed downstream are greater than the total cross-sections of the pore channels of the filter layers disposed upstream.

3. The filter having a multi-layered structure of claim 1, wherein the cross-sections of the pore channels within each of the filter layers are identical to one another.

4. The filter having a multi-layered structure of claim 1, wherein the number of the pore channels of the filter layers disposed upstream is smaller than the number of the pore channels of the filter layers disposed downstream.

5. The filter having a multi-layered structure of claim 1, wherein a flow resistance buffer layer that temporarily receives the molten metal is formed between each two of the filter layers.

6. The filter having a multi-layered structure of claim 1, wherein the impurity particles are compounds containing at least one of lead (Pb), bismuth (Bi), iron (Fe), and silicon (Si).

7. The filter having a multi-layered structure of claim 1, wherein the filter layers are formed of ceramics.

8. A filter having a multi-layered structure for removing impurity particles from a molten metal, the filter comprising:
a plurality of filter layers sequentially disposed along the flow direction of the molten metal in a downward direction and comprising a plurality of pore channels,
wherein the filter layers disposed upstream comprise larger pore channels than those of the filter layers disposed downstream, and
wherein the plurality of the filter layers comprise a first, second, third, fourth, fifth, and sixth filter layers, sequentially in a downstream direction, and
wherein the density of the pore channels of the first filter layer is 5 ppi (pores per square inch), and
the density of the pore channels of the second filter layer is 10 ppi, and
the density of the pore channels of the third filter layer is 15 ppi, and
the density of the pore channels of the fourth filter layer is 20 ppi, and
the density of the pore channels of the fifth filter layer is 25 ppi, and
the density of the pore channels of the sixth filter layer is 30 ppi.
